(19) United States
(12) Patent Application Publication
(10) Pub. No.: US 2026/0042335 A1
(43) Pub. Date: Feb. 12, 2026

(54) MANIFOLD FLUID MODULE

(71) Applicant: Hanon Systems, Daejeon (KR)

(72) Inventors: In Keun KANG, Daejeon (KR); Young Man KIM, Daejeon (KR); In Hyeok KIM, Daejeon (KR); Jae Kyun KIM, Daejeon (KR); Kyeong Cheol LEE, Daejeon (KR); Jae Min LEE, Daejeon (KR)

(73) Assignee: Hanon Systems, Daejeon (KR)

(21) Appl. No.: 18/994,832

(22) PCT Filed: Jun. 23, 2023
(86) PCT No.: PCT/KR2023/008753

§ 371 Date: Jan. 15, 2025

(30) Foreign Application Priority Data
Jul. 15, 2022 (KR) 10-2022-0087570

(51) Int. Cl. B60H 1/00; B60H 1/32

(52) U.S. Cl. CPC B60H 1/00899; B60H 1/00485; B60H 1/3229

(57) ABSTRACT

The present invention relates to a manifold fluid module. A manifold fluid module according to an embodiment of the present invention may include a manifold plate having therein a plurality of fluid flow paths through which fluids having different temperatures move, and a heat transfer inhibitor provided between a high-temperature fluid flow path and a low-temperature fluid flow path to block heat transfer from a flow path, through which a high-temperature fluid moves, to a flow path through which the low-temperature fluid moves.

### TECHNICAL FIELD

The present invention relates to a manifold fluid module, and more particularly, to a manifold fluid module in which components, such as heat exchangers and valves, are modularized into a single component.

### BACKGROUND ART

As development and research have been conducted on environmental-friendly technologies and alternative energy sources for replacing fossil raw materials, and electric vehicles and hybrid vehicles have been considered as most attractive fields in recent vehicle industries. Batteries are mounted in the electric vehicles and hybrid vehicles to provide driving power. The power of the battery is used not only to drive the vehicle, but also to cool or heat a vehicle interior.

When the battery is used as a heat source for cooling or heating the interior of the vehicle that provides driving power by using the battery, the traveling distance decreases to that extent. To solve this problem, a method of applying a heat pump system, which has been widely used as a domestic cooling or heating device in the related art, to the vehicle has been proposed.

For reference, the heat pump refers to a process of absorbing low-temperature heat and transferring the absorbed heat to a high-temperature location. For example, the heat pump implements a cycle in which a liquid fluid becomes a gaseous fluid by evaporating in an evaporator and absorbing heat from the surrounding, and the gaseous fluid becomes the liquid fluid by dissipating heat to the surrounding by means of a condenser. The application of the thermal management system to the electric or hybrid vehicle may advantageously ensure an insufficient heat source in a general air conditioning device in the related art.

In a modularized configuration of a current heat pump system for an electric vehicle, important components (a valve, an accumulator, a chiller, a condenser, an internal heat exchanger, a sensor, and the like) are connected by pipes in a partially modularized manner. Fittings and connectors need to be separately configured in order to connect the pipes, and an appropriate interval is defined to connect the components. For this reason, there are disadvantages in terms of packaging, costs, and workability.

In order to cope with the disadvantages, a technology for modularizing a manifold is being developed. However, there is a problem in that performance is degraded by thermal interference between a high-temperature fluid and a low-temperature fluid during the modularization process.

### DISCLOSURE

### Technical Problem

An object of an embodiment of the present invention is to provide a manifold fluid module capable of dividing a region of a fluid into a high-temperature region and a low-temperature region, thereby minimizing thermal interference between refrigerants and improving heat pump performance.

### Technical Solution

An embodiment of the present invention provides a manifold fluid module including: a manifold plate having therein a plurality of fluid flow paths through which fluids having different temperatures move; and a heat transfer inhibitor provided between a high-temperature fluid flow path and a low-temperature fluid flow path to block heat transfer from a flow path, through which a high-temperature fluid moves, to a flow path through which the low-temperature fluid moves, in which the high-temperature fluid flow path and the low-temperature fluid flow path are connected by a connection part.

The connection part may connect parts of the manifold plate separated by the heat transfer inhibitor, and the fluid may move to the connection part.

In a thermal management system including a compressor, a plurality of heat exchangers, a plurality of valves, and an expansion valve, at least one heat exchanger, at least one valve, and the expansion valve may be coupled to the manifold plate.

The fluid may move to the connection part in a heating mode of the thermal management system, and the fluid may not move to the connection part in a cooling mode.

The manifold fluid module may further include: a first heat exchanger coupled to the manifold plate and configured to allow a first fluid and a second fluid to exchange heat with each other; and a second heat exchanger coupled to the manifold plate and configured to allow the first fluid, which is discharged from the first heat exchanger, to exchange heat with the second fluid.

The manifold plate may include: a main plate having therein the plurality of fluid flow paths; and a bottom plate coupled to one surface of the main plate and configured to cover the fluid flow path.

The main plate may include: a first main plate along which a high-temperature first fluid passing through the first heat exchanger moves; and a second main plate along which a low-temperature first fluid passing through the second heat exchanger moves, and the heat transfer inhibitor may be formed between the first main plate and the second main plate.

The bottom plate may include: a first bottom plate coupled to cover at least one surface of the first main plate; and a second bottom plate coupled to cover at least one surface of the second main plate, and the heat transfer inhibitor may be formed between the first bottom plate and the second bottom plate.

One side of the first bottom plate and one side of the second bottom plate may communicate with each other by the connection part.

The connection part may have a pipe shape.

The fluid may move to the connection part in a heating mode, and the fluid may not move to the connection part in a cooling mode.

The manifold fluid module may further include: a first expansion valve configured to expand the first fluid introduced into the first heat exchanger; and a second expansion valve configured to expand the first fluid introduced into the second heat exchanger, in which the first expansion valve is disposed above the first heat exchanger, the second expansion valve is disposed above the second heat exchanger, such that the first fluid introduced into the first heat exchanger and the second heat exchanger moves from above to below.

The manifold fluid module may further include: a first direction switching valve and a second direction switching valve configured to control a direction of the first fluid discharged from the first heat exchanger, in which the first direction switching valve is disposed below the second heat exchanger, and the second direction switching valve is disposed above the second heat exchanger.

The second main plate may have an accumulator port through which the first fluid is discharged to an accumulator, and the connection part may be provided to allow the second direction switching valve and the accumulator port to communicate with each other.

The connection part may be disposed between the second direction switching valve and the second heat exchanger.

The manifold plate may have an opening portion formed in a portion where the second heat exchanger is disposed, and the heat transfer inhibitor may include a first heat transfer inhibitor and a second heat transfer inhibitor respectively formed above and below the opening portion.

The manifold plate may have an opening portion formed in a portion where the second heat exchanger is disposed, the heat transfer inhibitor may include a first heat transfer inhibitor and a second heat transfer inhibitor respectively formed above and below the opening portion, the first heat transfer inhibitor may be formed to cut out a portion between the second expansion valve and the first direction switching valve, and the second heat transfer inhibitor may be formed to cut out a portion between the second heat exchanger and the first direction switching valve.

### Advantageous Effects

The manifold fluid module according to the embodiment of the present invention employs the structure capable of blocking thermal conduction between the high-temperature fluid and the low-temperature fluid, thereby improving the heat pump performance.

### DESCRIPTION OF DRAWINGS

FIG. 1 is a view illustrating a front surface of a manifold fluid module according to an embodiment of the present invention.

FIG. 2 is a view illustrating a rear surface of a main plate of the manifold fluid module according to the embodiment of the present invention.

FIG. 3 is a view illustrating a state in which a refrigerant is discharged to an accumulator port from the manifold fluid module according to the embodiment of the present invention.

FIG. 4 is a view illustrating a state in which a bottom plate is coupled to the main plate illustrated in FIG. 2.

FIG. 5 is a view illustrating the amount of heat transfer before a cut-out structure is applied to the manifold fluid module according to the embodiment of the present invention.

FIG. 6 is a view illustrating the amount of heat transfer after the cut-out structure is applied to the manifold fluid module according to the embodiment of the present invention.

### MODE FOR INVENTION

The present invention may be variously modified and may have various embodiments, and particular embodiments illustrated in the drawings will be described in detail below. However, the description of the exemplary embodiments is not intended to limit the present invention to the particular exemplary embodiments, but it should be understood that the present invention is to cover all modifications, equivalents and alternatives falling within the spirit and technical scope of the present invention. In the description of the present invention, the specific descriptions of publicly known related technologies will be omitted when it is determined that the specific descriptions may obscure the subject matter of the present invention.

The terms such as “first” and “second” may be used to describe various constituent elements, but the constituent elements should not be limited by the terms. These terms are used only to distinguish one constituent element from another constituent element.

The terminology used herein is used for the purpose of describing particular example embodiments only and is not intended to be limiting. Singular expressions include plural expressions unless clearly described as different meanings in the context. In the present application, the terms “comprises,” “comprising,” “includes,” “including,” “containing,” “has,” “having” or other variations thereof are inclusive and therefore specify the presence of stated features, integers, steps, operations, elements, components, and/or combinations thereof, but do not preclude the presence or addition of one or more other features, integers, steps, operations, elements, components, and/or combinations thereof.

In addition, throughout the specification, when one constituent element is referred to as being “connected to” another constituent element, one constituent element can be “directly connected to” the other constituent element, and one constituent element can also be “indirectly connected to,” “physically connected to,” or “electrically connected to” the other element with other elements therebetween. Further, the constituent elements are defined as different names according to positions or functions thereof, but the constituent elements may be integrated.

Hereinafter, embodiments of a manifold fluid module according to the present invention will be described in detail with reference to the accompanying drawings. In the description of the exemplary embodiments with reference to the accompanying drawings, the same or corresponding constituent elements are assigned with the same reference numerals, and the repetitive description thereof will be omitted.

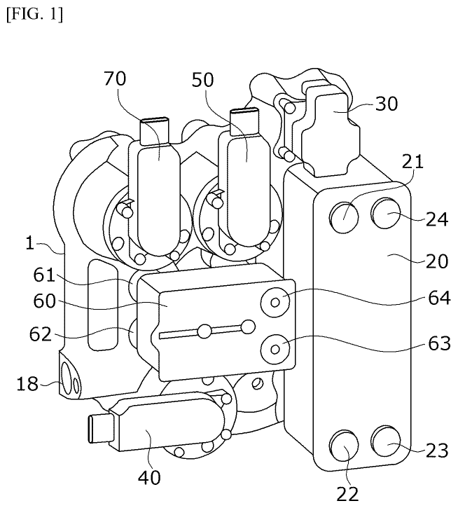

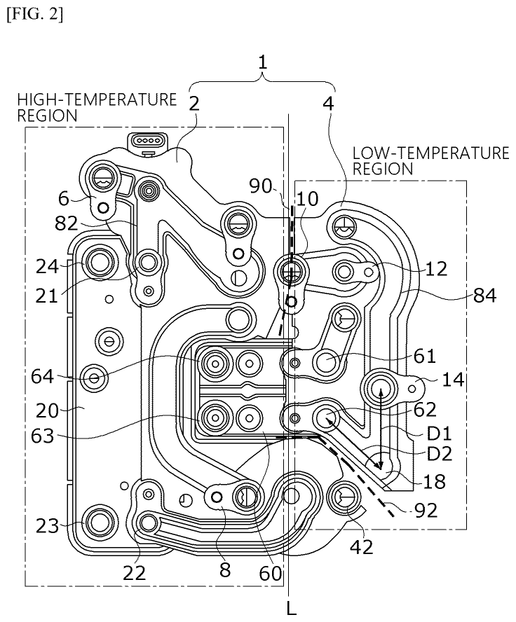

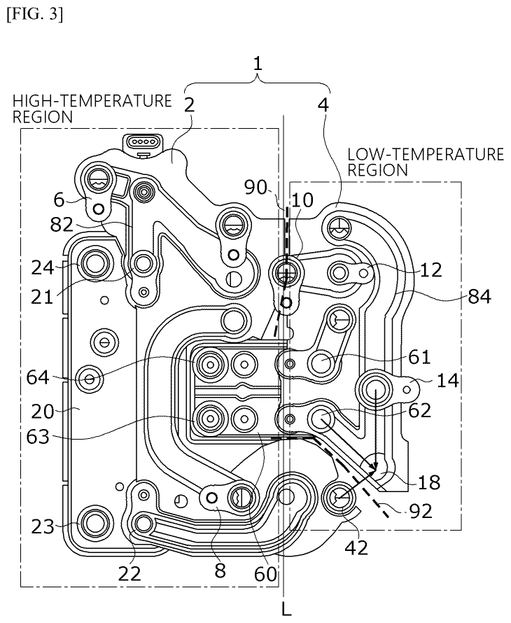

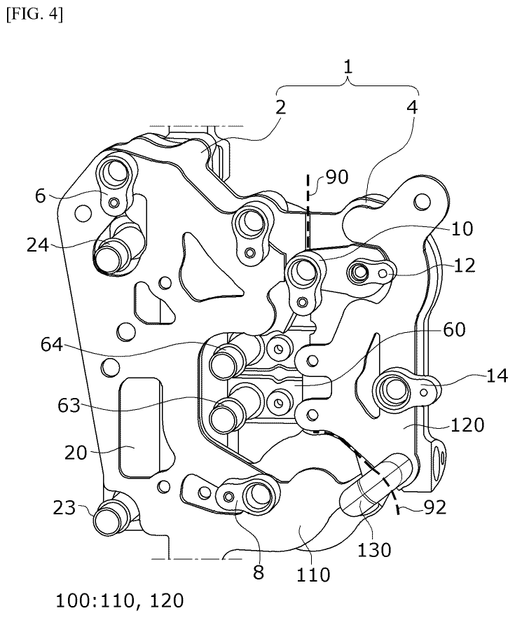

FIG. 1 is a view illustrating a front surface of a manifold fluid module according to an embodiment of the present invention, FIG. 2 is a view illustrating a rear surface of a main plate of the manifold fluid module according to the embodiment of the present invention, FIG. 3 is a view illustrating a state in which a refrigerant is discharged to an accumulator port from the manifold fluid module according to the embodiment of the present invention, and FIG. 4 is a view illustrating a state in which a bottom plate is coupled to the main plate illustrated in FIG. 2.

As illustrated in the drawings, a manifold fluid module according to an embodiment of the present invention may include a manifold plate 1 or 100 having therein a plurality of fluid flow paths through which fluids having different temperatures flow, and heat transfer inhibitors 90 and 92 provided between a high-temperature side flow path and a low-temperature side flow path and configured to block heat transfer from a flow path, through which a high-temperature fluid flows, to a flow path through which a low-temperature fluid flows. The high-temperature side flow path and the low-temperature side flow path may be connected by a connection part 130.

The manifold plate 1 or 100 includes an assembly including a main plate 1 and a bottom plate 100. The manifold plate may be manufactured by coupling the assembly by using brazing, a structural bonding agent (structural adhesive), a gasket, and the like. In addition, various materials, such as aluminum, thermoplastic plastic, or stainless steel, may be applied as a material of the manifold plate 1 or 100 depending on manufacturing methods, purposes, and functions.

The main plate 1 has a plate shape in which a fluid flow path is recessed approximately inward, and the main plate 1 has a predetermined thickness. As described above, first and second heat exchangers 20 and 60, which are heat exchange devices of a heat pump system, expansion valves 30 and 70, and direction switching valves 40 and 50 are coupled to the main plate 1 and modularized, such that the number of processes of manufacturing products may be reduced, and the number of processes of the vehicle assembling line may be reduced. In addition, because the main plate 1 simultaneously serves as a pipe, a fitting, and a housing, costs may be reduced, and workability may be improved. That is, in a thermal management system including a compressor, a plurality of heat exchangers, a plurality of valves, and an expansion valve, one or more heat exchangers 20 and 60, one or more direction switching valves 40 and 50, and one or more expansion valves 30 and 70 may be coupled to the manifold plate 1 or 100.

With reference to FIG. 2, a fluid inlet port 6 is provided on a rear surface of the main plate 1, and a high-temperature, high-pressure gas-phase fluid discharged from a compressor or an internal condenser is introduced into the fluid inlet port 6. Further, the fluid flow paths may be formed in the rear surface of the main plate 1 and guide the flow of the fluid subjected to heat exchange, expansion, introduction, and discharge.

In addition, various types of fluid ports may be provided on the rear surface of the main plate 1 to introduce and discharge the fluid. In the present embodiment, there are provided an external heat exchanger discharge port 8 through which a first fluid is discharged to an external heat exchanger (air-cooled condenser), and an external heat exchanger inlet port 10 through which the first fluid is introduced from the external heat exchanger. In addition, there are provided an evaporator discharge port 12 through which the first fluid is discharged to an evaporator (not illustrated), and an evaporator inlet port 14 through which the first fluid is introduced from the evaporator. The arrangement of the evaporator inlet port 14 will be described below more specifically. Additionally, there is provided an accumulator port 18 through which the first fluid discharged from the second heat exchanger 60 to an accumulator (not illustrated).

With reference back to FIG. 1, the first heat exchanger 20 and the second heat exchanger 60, which are the heat exchange devices, are coupled to the manifold plate 1 or 100. The first fluid and a second fluid may exchange heat with each other while passing through the first heat exchanger 20 and the second heat exchanger 60.

In the present embodiment, a water-cooled condenser may be used as the first heat exchanger 20, and a chiller may be used as the second heat exchanger 60. The water-cooled condenser serves to condense a high-temperature, high-pressure gas-phase fluid (refrigerant), which is discharged from a compressor or an internal condenser into a high-pressure liquid by allowing the gas-phase fluid to exchange heat with an external heat source. The chiller refers to a device configured to be supplied with a low-temperature, low-pressure fluid and exchange heat with a fluid (coolant) flowing along a coolant circulation line (not illustrated). The cool coolant, which has exchanged heat with the chiller, may circulate through the coolant circulation line and exchange heat with the battery.

Meanwhile, the refrigerants, the coolants, and the like may be applied as the first and second fluids. In the present embodiment, the refrigerant is applied as the first fluid, and the coolant is applied as the second fluid.

The first heat exchanger 20 has a first fluid port through which the first fluid is introduced and discharged. The first fluid port includes a first inlet end 21 and a first discharge end 22 respectively provided at upper and lower ends of the first heat exchanger 20. The first inlet end 21 refers to a portion through which the first fluid having passed through a first expansion valve 30 is introduced, and the first discharge end 22 refers to a portion through which the first fluid having exchanged heat with the first heat exchanger 20 is discharged. The first inlet end 21 and the first discharge end 22 may be respectively formed in hole shapes at the upper and lower ends of the first heat exchanger 20.

In this case, in consideration of thermal interference, the first inlet end 21 may be formed at one side close to the first expansion valve 30, and the first discharge end 22 may be formed at the other side distant from the first expansion valve 30. More specifically, the first inlet end 21 may be disposed to be closer to the first expansion valve 30 than the first discharge end 22 to the first expansion valve 30. For example, a distance from the first expansion valve 30 to the first inlet end 21 may be shorter than a distance from the first expansion valve 30 to the first discharge end 22.

Further, the first heat exchanger 20 has a second fluid port through which the second fluid is introduced and discharged. The second fluid port includes a second inlet end 23 and a second discharge end 24 respectively provided at the lower and upper ends of the first heat exchanger 20. The second inlet end 23 refers to a portion through which the second fluid is introduced, and the second discharge end 24 refers to a portion through which the second fluid having exchanged heat with the first fluid is discharged. The second fluid exchanges heat with the first fluid while flowing in a direction (from below to above) opposite to the direction in which the first fluid flows.

Because the above-mentioned first and second fluid ports are disposed to be spaced apart from each other, assemblability of first and second fluid pipes may be improved.

The first expansion valve 30 serves to control whether to expand the refrigerant to be introduced into the first heat exchanger 20. The first expansion valve 30 may be disposed above the first heat exchanger 20 and expand the first fluid introduced through the fluid inlet port 6 or allow the first fluid to pass therethrough. The first fluid introduced through the first expansion valve 30 may perform heat exchange while passing through the first heat exchanger 20 or flow to the external heat exchanger.

The first fluid discharged through the first discharge end 22 of the first heat exchanger 20 is introduced into the first direction switching valve 40. The first direction switching valve 40 serves to control the direction of the first fluid discharged from the first heat exchanger 20. In a cooling mode, the first direction switching valve 40 discharges the first fluid to the external heat exchanger (air-cooled condenser) through the external heat exchanger discharge port 8. In a heat pump mode, the first direction switching valve 40 changes the direction of the first fluid toward the accumulator port 18 and discharges the first fluid to the accumulator. The first fluid is introduced into a low-temperature fluid flow path 84 through a first fluid inlet port 42 formed on the manifold plate 1 or 100.

In addition, the first fluid introduced into the first expansion valve 30 may move to a second direction switching valve 50 and then move to the evaporator in a dehumidification mode.

A low-temperature, low-pressure fluid is supplied to the second heat exchanger 60 and exchange heat with the coolant moving through a coolant circulation line (not illustrated). The cool coolant, which has exchanged heat with the second heat exchanger 60, may circulate through the coolant circulation line and exchange heat with the battery. The first fluid having exchanged heat with the external heat exchanger is introduced into the second expansion valve 70, and the first fluid expanded by the second expansion valve 70 is introduced into the second heat exchanger 60. The first fluid having exchanged heat with the second heat exchanger 60 is discharged through a lower end and introduced into the accumulator (not illustrated).

To this end, the second heat exchanger 60 has the first fluid port through which the first fluid is introduced and discharged. The first fluid port includes a first inlet end 61 and a first discharge end 62 respectively provided at upper and lower ends of the second heat exchanger 60. The first inlet end 61 refers to a portion through which the first fluid is introduced, and the first discharge end 62 refers to a portion through which the first fluid having exchanged heat with the second heat exchanger 60 is discharged. The first inlet end 61 and the first discharge end 62 may be respectively formed in hole shapes at the upper and lower ends of the second heat exchanger 60.

In this case, in consideration of thermal interference, the first inlet end 61 of the second heat exchanger 60 may be formed at one side close to the second expansion valve 70, and the first discharge end 62 may be formed at the other side distant from the second expansion valve 70. More specifically, the first inlet end 61 may be disposed to be closer to the second expansion valve 70 than the first discharge end 62 to the second expansion valve 70. For example, a distance from the second expansion valve 70 to the first inlet end 61 may be shorter than a distance from the second expansion valve 70 to the first discharge end 62.

In addition, the second heat exchanger 60 has the second fluid port through which the second fluid is introduced and discharged. The second fluid port includes a second inlet end 63 and a second discharge end 64 respectively provided at the lower and upper ends of the second heat exchanger 60. The second inlet end 63 refers to a portion through which the second fluid is introduced, and the second discharge end 64 refers to a portion through which the second fluid having exchanged heat with the first fluid is discharged. The second fluid exchanges heat with the first fluid while flowing in a direction (from below to above) opposite to the direction in which the first fluid flows.

With reference back to FIG. 1, in the present embodiment, the first expansion valve 30, the second direction switching valve 50, and the second expansion valve 70 may be disposed on an upper portion of the manifold plate 1 or 100, the first heat exchanger 20 may be disposed at one side of a lower portion of the manifold plate 1 or 100, and the second heat exchanger 60 and the first direction switching valve 40 may be disposed at the other side of the lower portion of the manifold plate 1 or 100. In this case, the first direction switching valve 40 may be disposed below the second heat exchanger 60, and the second direction switching valve 50 may be disposed above the second heat exchanger 60.

When the above-mentioned components are disposed on the manifold plate 1 or 100, the spatial efficiency may be maximized because the components may be optimally disposed in a minimum space, and the flow of the fluid may be optimized because the flow of the fluid is formed from above to below entirely.

In particular, the first heat exchanger 20 is disposed in a vertical direction at one side of the lower portion of the manifold plate 1 or 100, and the second heat exchanger 60 is disposed in a horizontal direction at the other side of the lower portion of the manifold plate 1 or 100, such that the fluid module package may be optimized. That is, the second heat exchanger 60 may be disposed in a lateral direction of the first heat exchanger 20, thereby improving the spatial efficiency. In addition, the first expansion valve 30 is disposed above the first heat exchanger 20, and the second expansion valve 70 is disposed above the second heat exchanger 60, such that the flow of the first fluid may be naturally formed from above to below.

An imaginary reference line L is formed on the manifold plate 1 or 100. Based on the imaginary reference line L, the first heat exchanger 20, the first expansion valve 30, the first direction switching valve 40, and the second direction switching valve 50 may be disposed at one side, and the second heat exchanger 60 and the second expansion valve 70 may be disposed at the other side.

More specifically, in the cooling mode, a high-temperature region, in which a high-temperature first fluid flows, and a low-temperature region, in which a low-temperature first fluid flows, are separated based on the imaginary reference line L. A high-temperature fluid flow path 82, through which the high-temperature first fluid moves, is formed in the high-temperature region, and the low-temperature fluid flow path 84, through which the low-temperature first fluid moves, is formed in the low-temperature region. Further, constituent elements for moving the high-temperature first fluid may be disposed in the high-temperature region, and constituent elements for moving the low-temperature first fluid may be disposed in the low-temperature region. Therefore, thermal interference between the high-temperature and low-temperature first fluids may be minimized, and the performance of the heat pump system may be improved. In the drawings, the high-temperature region may include a left portion and a lower end portion, and the low-temperature region may include a right portion excluding a right lower end.

With reference to FIGS. 2 to 4, the main plate 1 may include a first main plate 1 along which the high-temperature first fluid passing through the first heat exchanger 20 moves, and a second main plate 4 along which the low-temperature first fluid passing through the second heat exchanger 60 moves. In this case, a portion between the first main plate 1 and the second main plate 4 is cut out, such that the first main plate 1 and the second main plate 4 may be physically separated from each other.

As described above, when the first main plate 1 and the second main plate 4 are separated by means of the cut-out structure, a direct heat transfer route between the high-temperature region and the low-temperature region is blocked, which may improve the heat pump performance.

The cut-out structure between the first main plate 1 and the second main plate 4 may be implemented in various ways. With reference to the present drawings, the heat transfer inhibitors 90 and 92 are provided between the first main plate 1 and the second main plate 4. The heat transfer inhibitors 90 and 92 may be provided at two portions to effectively block the heat transfer between the high-temperature region and the low-temperature region.

A portion of the manifold plate 1 or 100 on which the second heat exchanger 60 is disposed may have an opening portion 80 opened forward and rearward in most parts. The opening portion 80 refers to a portion formed to prevent interference between the second inlet end 63 and the second discharge end 64 of the second heat exchanger 60. The opening portion 80 refers to a portion formed to allow the high-temperature region and the low-temperature region of the manifold plate 1 or 100 to be maximally spaced apart from each other.

The heat transfer inhibitors 90 and 92 may be respectively formed above and below the opening portion 80. The first heat transfer inhibitor 90 may be formed above the opening portion 80 in an approximately vertical direction, and the second heat transfer inhibitor 92 may be formed at one side of a lower portion of the opening portion 80 in an approximately horizontal direction. Of course, the positions of the heat transfer inhibitors 90 and 92 are not limited to the positions illustrated in the present drawings. The positions of the heat transfer inhibitors 90 and 92 may be any position as long as the heat transfer inhibitors 90 and 92 may separate the high-temperature region and the low-temperature region.

That is, because the heat transfer inhibitors 90 and 92 are respectively formed above and below the opening portion 80 formed in the central portion of the manifold plate 1 or 100, the high-temperature region positioned at the left side and the low-temperature region positioned at the right side may be separated from each other.

Meanwhile, the heat transfer inhibitors 90 and 92 may be formed at the positions relative to the components disposed on the manifold plate 1 or 100. The first heat transfer inhibitor 90 may be formed to cut out a portion between the second expansion valve 70 and the first direction switching valve 50, and the second heat transfer inhibitor 92 may be formed to cut out a portion between the second heat exchanger 60 and the first direction switching valve 40. This is to block the heat transfer route by allowing the heat transfer inhibitors 90 and 92 to cut out the portion between the configuration in which the high-temperature first fluid moves and the configuration in which the low-temperature first fluid moves.

In addition, in order to minimize the heat transfer route between the high-temperature region and the low-temperature region, the evaporator inlet port 14 may be disposed as follows. The evaporator inlet port 14 is disposed in the low-temperature fluid flow path 84, and the low-temperature first fluid introduced through the evaporator inlet port 14 is moved downward and discharged to the outside through the accumulator port 18. In this case, as a section in which the first fluid moves is lengthened, the low-temperature first fluid may receive heat from the high-temperature first fluid. Therefore, in the present embodiment, the evaporator inlet port 14 is disposed to be maximally close to the accumulator port 18, such that the section in which the low-temperature first fluid moves is minimized.

The low-temperature fluid flow path 84 may be connected to the plurality of fluid inlet ports, and the fluid inlet ports may include the first fluid inlet port 42, the second discharge end 62 of the second heat exchanger 60, and the evaporator inlet port 14. Among the fluid inlet ports, the evaporator inlet port 14 is connected to the discharge port of the evaporator, such that the first fluid having exchanged heat with the evaporator is introduced into the evaporator inlet port 14.

The evaporator inlet port 14 may be basically disposed on the second main plate 4 along which the low-temperature first fluid moves. The evaporator inlet port 14 may be disposed adjacent to the first inlet end 61 of the second heat exchanger 60. More specifically, the evaporator inlet port 14 may be disposed between the first inlet end 61 and the first discharge end 62 of the second heat exchanger 60. That is, because the evaporator inlet port 14 is disposed adjacent to the second heat exchanger 60 that exchanges heat with the low-temperature first fluid, it is possible to minimize a degree to which the first fluid introduced into the evaporator inlet port 14 receives heat.

A distance D1 between the evaporator inlet port 14 and the accumulator port 18 may be equal to or shorter than a distance D2 between the first discharge end 62 of the second heat exchanger 60 and the accumulator port 18. This is to minimize the heat transfer from the first fluid, which is discharged from the second heat exchanger 60, to the first fluid introduced into the evaporator inlet port 14.

With reference to FIG. 4, the bottom plate 100 is coupled to one surface, i.e., a rear surface of the main plate 1 and covers the fluid flow path. The bottom plate 100 may include a first bottom plate 110 coupled to cover at least one surface of a first main plate 2, and a second bottom plate 120 coupled to cover at least one surface of the second main plate 4. As well illustrated in the drawings, the first bottom plate 110 and the second bottom plate 120 may be coupled to cover most parts of one surface of each of the first main plate 2 and the second main plate 4.

In this case, one side of the first bottom plate 110 and one side of the second bottom plate 120 may communicate with each other by a connection part 130. Because the main plate 1 is divided by the heat transfer inhibitors 90 and 92, the bottom plate 100 coupled to the main plate 1 may also be divided. In this case, in a heat pump mode, a route through which the first fluid moves from the first direction switching valve 40 to the accumulator port 18 is blocked. Therefore, in the present embodiment, the first bottom plate 110 and the second bottom plate 120 communicate with each other by the connection part 130 in order to ensure the flow path for the first fluid.

The connection part 130 allows the first fluid to flow in the heating mode of the thermal management system, i.e., in case that a fluid temperature difference between the high-temperature flow path and the low-temperature flow path is small. In the cooling mode, i.e., in case that the fluid temperature difference between the high-temperature flow path and the low-temperature flow path is large, the first fluid does not flow.

As illustrated in the present drawings, the connection part 130 is formed in a pipe shape, such that the flow path for the first fluid in the connection part 130 may be ensured. In addition, one side of the first bottom plate 110 and one side of the second bottom plate 120 are connected in a plate shape, and the flow path may be formed in the connection part 130.

The connection part 130 serves as the flow path as described above and also serves to improve the durability of the manifold plate 1 or 100. More specifically, in the present embodiment, because the manifold plate 1 or 100 is divided into the two components, the coupling structure is maintained only by the components coupled to the manifold plate 1 or 100. In this case, the manifold plate 1 or 100 may be vulnerable to an external impact without being rigid. Therefore, the connection part 130 may connect the two separated components of the manifold plate 1 or 100, thereby more securely maintaining the coupling structure.

As described above, the configuration has been described in which the manifold plate 1 or 100 is configured by coupling the main plate 1 and the bottom plate 100, and the connection part 130 is provided on the bottom plate 100. However, the present invention is not limited thereto. For example, the connection part 130 may be provided on the main plate 1. Alternatively, the manifold plate 1 or 100 may be provided as a single plate, and the connection part 130 may be provided on the manifold plate 1 or 100.

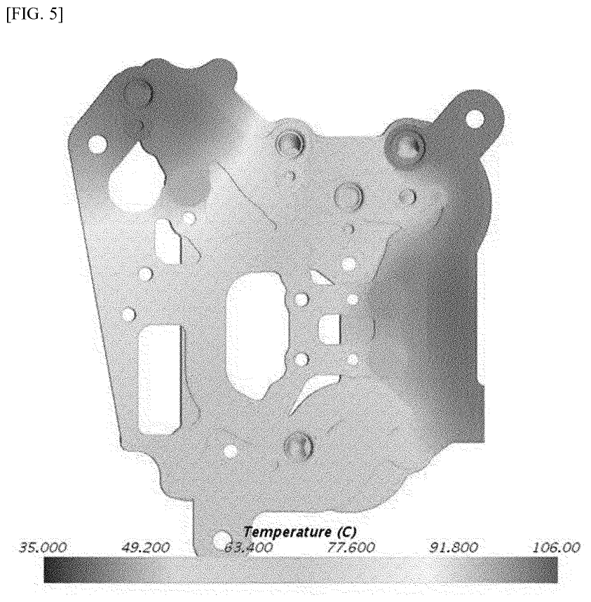

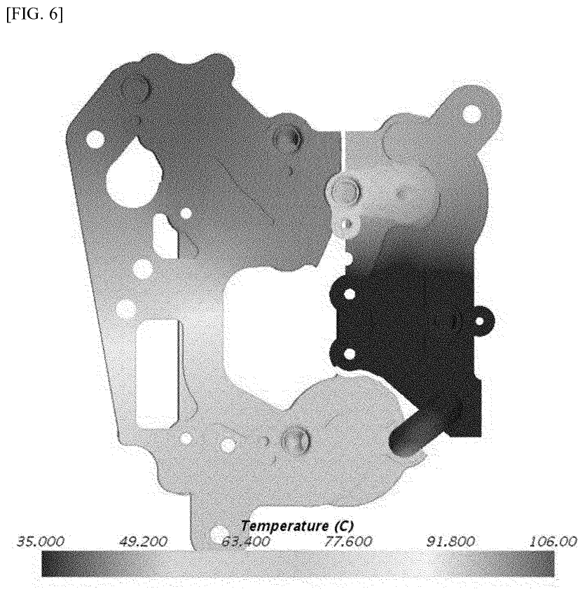

FIG. 5 is a view illustrating the amount of heat transfer before the cut-out structure is applied to the manifold fluid module according to the embodiment of the present invention, and FIG. 6 is a view illustrating the amount of heat transfer after the cut-out structure is applied to the manifold fluid module according to the embodiment of the present invention.

With reference to FIGS. 5 and 6, before the cut-out structure is applied to the manifold fluid module, the portion of the manifold plate 1 or 100 where the low-temperature first fluid moves has a relatively high temperature.

In contrast, it can be ascertained that after the cut-out structure is applied to the manifold fluid module, the portion of the manifold plate 1 or 100 where the low-temperature first fluid moves has a relatively low temperature. This is because the cut-out structure blocks the heat transfer from the high-temperature first fluid to the low-temperature first fluid. In addition, it is possible to minimize the heat transfer by maximally shortening the section in which the low-temperature first fluid introduced into the evaporator inlet port 14 moves.

While the present invention has been described above with reference to the particular embodiments, it may be understood by those skilled in the art that the present invention may be variously modified and changed without departing from the spirit and scope of the present invention disclosed in the claims.

[Description of Reference Numerals]

| | |
|---|---|
| 1: Main plate | 2: First main plate |
| 4: First main plate | 6: Fluid inlet port |
| 8: External heat exchanger discharge | 10: External heat exchanger inlet |
| port | port |
| 12: Evaporator discharge port | 14: Evaporator inlet port |
| 18: Accumulator port | 20: First heat exchanger |
| 21: First inlet end | 22: First discharge end |
| 23: Second inlet end | 24: Second discharge end |
| 30: First expansion valve | 40: First direction switching valve |
| 50: Second direction switching valve | 60: Second heat exchanger |
| 61: First inlet end | 62: First discharge end |
| 63: Second inlet end | 64: Second discharge end |
| 70: Second expansion valve | 80: Opening portion |
| 82: High-temperature fluid flow path | 84: Low-temperature fluid flow |
| 90: First heat transfer inhibitor | 92: Second heat transfer inhibitor |
| 100: Bottom plate | 110: First bottom plate |
| 120: Second bottom plate | 130: Connection part |

1. A manifold fluid module comprising:
a manifold plate having therein a plurality of fluid flow paths through which fluids having different temperatures move; and
a heat transfer inhibitor provided between a high-temperature fluid flow path and a low-temperature fluid flow path to block heat transfer from a flow path, through which a high-temperature fluid moves, to a flow path through which the low-temperature fluid moves,
wherein the high-temperature fluid flow path and the low-temperature fluid flow path are connected by a connection part.

2. The manifold fluid module of claim 1, wherein the connection part connects parts of the manifold plate separated by the heat transfer inhibitor, and the fluid moves to the connection part.

3. The manifold fluid module of claim 1, wherein in a thermal management system comprising a compressor, a plurality of heat exchangers, a plurality of valves, and an expansion valve, at least one heat exchanger, at least one valve, and the expansion valve are coupled to the manifold plate.

4. The manifold fluid module of claim 3, wherein the fluid moves to the connection part in a heating mode of the thermal management system, and the fluid does not move to the connection part in a cooling mode.

5. The manifold fluid module of claim 1, further comprising:
a first heat exchanger coupled to the manifold plate and configured to allow a first fluid and a second fluid to exchange heat with each other; and
a second heat exchanger coupled to the manifold plate and configured to allow the first fluid, which is discharged from the first heat exchanger, to exchange heat with the second fluid.

6. The manifold fluid module of claim 5, wherein the manifold plate comprises:
a main plate having therein the plurality of fluid flow paths; and
a bottom plate coupled to one surface of the main plate and configured to cover the fluid flow path.

7. The manifold fluid module of claim 6, wherein the main plate comprises:
a first main plate along which a high-temperature first fluid passing through the first heat exchanger moves; and
a second main plate along which a low-temperature first fluid passing through the second heat exchanger moves, and
wherein the heat transfer inhibitor is formed between the first main plate and the second main plate.

8. The manifold fluid module of claim 7, wherein the bottom plate comprises:
a first bottom plate coupled to cover at least one surface of the first main plate; and
a second bottom plate coupled to cover at least one surface of the second main plate, and
wherein the heat transfer inhibitor is formed between the first bottom plate and the second bottom plate.

9. The manifold fluid module of claim 8, wherein one side of the first bottom plate and one side of the second bottom plate communicate with each other by the connection part.

10. The manifold fluid module of claim 9, wherein the connection part has a pipe shape.

11. The manifold fluid module of claim 9, wherein the fluid moves to the connection part in a heating mode, and the fluid does not move to the connection part in a cooling mode.

12. The manifold fluid module of claim 9, further comprising:
a first expansion valve configured to expand the first fluid introduced into the first heat exchanger; and
a second expansion valve configured to expand the first fluid introduced into the second heat exchanger,
wherein the first expansion valve is disposed above the first heat exchanger, the second expansion valve is disposed above the second heat exchanger, such that the first fluid introduced into the first heat exchanger and the second heat exchanger moves from above to below.

13. The manifold fluid module of claim 12, further comprising:
a first direction switching valve and a second direction switching valve configured to control a direction of the first fluid discharged from the first heat exchanger,
wherein the first direction switching valve is disposed below the second heat exchanger, and the second direction switching valve is disposed above the second heat exchanger.

14. The manifold fluid module of claim 13, wherein the second main plate has an accumulator port through which the first fluid is discharged to an accumulator, and the connection part is provided to allow the second direction switching valve and the accumulator port to communicate with each other.

15. The manifold fluid module of claim 13, wherein the connection part is disposed between the second direction switching valve and the second heat exchanger.

16. The manifold fluid module of claim 5, wherein the manifold plate has an opening portion formed in a portion where the second heat exchanger is disposed, and the heat transfer inhibitor comprises a first heat transfer inhibitor and a second heat transfer inhibitor respectively formed above and below the opening portion.

17. The manifold fluid module of claim 13, wherein the manifold plate has an opening portion formed in a portion where the second heat exchanger is disposed, the heat transfer inhibitor comprises a first heat transfer inhibitor and a second heat transfer inhibitor respectively formed above and below the opening portion, the first heat transfer inhibitor is formed to cut out a portion between the second expansion valve and the first direction switching valve, and the second heat transfer inhibitor is formed to cut out a portion between the second heat exchanger and the first direction switching valve.
